(19) United States
(12) Patent Application Publication
(10) Pub. No.: US 2017/0241372 A1
(43) Pub. Date: Aug. 24, 2017

(54) METHOD FOR MANUFACTURING PISTON FOR INTERNAL COMBUSTION ENGINE AND FRICTIONAL HOLE SEALING DEVICE FOR PISTON FOR INTERNAL COMBUSTION ENGINE

(71) Applicant: HITACHI AUTOMOTIVE SYSTEMS, LTD., Hitachinaka-shi, Ibaraki (JP)

(72) Inventor: Masato SASAKI, Sagamihara-shi, Kanagawa (JP)

(73) Assignee: HITACHI AUTOMOTIVE SYSTEMS, LTD., Hitachinaka-shi, Ibaraki (JP)

(21) Appl. No.: 15/519,875

(22) PCT Filed: Oct. 13, 2015
(86) PCT No.: PCT/JP2015/078863

§ 371 Date: Apr. 18, 2017

(30) Foreign Application Priority Data
Oct. 21, 2014 (JP) 2014-214113

(51) Int. Cl. F02F 3/12; B23K 20/12

(52) U.S. Cl. CPC F02F 3/12; B23K 20/127; B23K 20/1215; F02F 2200/00

(57) ABSTRACT

In a method for producing a piston, a flat end surface 44a of a rotary tool 44 of a frictional pore sealing device is brought into abutment with the top surface 5a of a low thermal conductivity member 5 cast on the crown surface 2a of an aluminum alloy piston 1, and this rotary tool is pressed against the low thermal conductivity member's side with a load while rotating the rotary tool through an electric motor and a speed reduction mechanism. With this, a frictional heat between the top surface of the low thermal conductivity member and the end surface of the rotary tool causes to form a plastic flow layer 5d on the top surface, thereby sealing an opening portion of a pore 9a on the top surface of the porous member 6.

### TECHNICAL FIELD

The present invention relates to a method for manufacturing an internal combustion engine's piston, which is provided on a crown surface of the piston with a porous, low thermal conductivity member, and to a frictional pore sealing device for the internal combustion engine's piston.

### BACKGROUND ART

As a conventional internal combustion engine's piston, there is known, for example, one described in the following Patent Publication 1 previously filed by the present applicant.

This piston is one applied to an internal combustion engine of an in-cylinder injection spark-ignition type, in which fuel is injected from a fuel injection valve toward the crown surface of a piston for its ignition and combustion. On the crown surface of a piston, there is formed by a vacuum casting method a porous, low thermal conductivity member made of a borosilicate glass having a thermal conductivity lower than that of an aluminum alloy base material of the piston.

That is, a porous member is previously disposed and held at a predetermined position in a vacuum casting mold. Then, when a piston is cast by injecting an aluminum alloy melt into the mold, the aluminum alloy melt infiltrates into pores of the porous member to form a low thermal conductivity member. This low thermal conductivity member is integrally fixed on the crown surface of the piston.

This low thermal conductivity member receives at its top surface a fuel direct injection from the fuel injection valve, thereby accelerating atomization and combustibility.

### PRIOR ART PUBLICATIONS

### Patent Publications

Patent Publication 1: Japanese Patent Application Publication 2014-25418

### SUMMARY OF THE INVENTION

### Task to be Solved by the Invention

In the piston described in Patent Publication 1, however, many pores are formed with openings not only in the inside of the porous member but also on its surface. Therefore, the injected fuel penetrates into each pore on the surface.

As a result of this, there is a fear that, particularly at the start of the engine, fuel in each pore is exhausted as it is, thereby deteriorating the exhaust emission performance of HC, etc.

Thus, as a method for sealing each pore, it is considered to apply an anodic oxide coating to the outside surface of the low thermal conductivity member (porous member). In this method, however, the coating is formed along concaves and convexes on the surface. Therefore, there is a fear that it is not possible to conduct sealing in case that the pores open on the surface are relatively large in size.

The present invention was made in view of the above-mentioned conventional technical task. Its object is to provide a piston production method and its production device, by which, irrespective of the opening area of the pores, the pores can be sealed by conducting a pore sealing treatment that the porous member is mechanically pressurized to make the resulting frictional heat form a plastic flow layer on the surface.

### Means for Solving the Task

The present invention provides a method for producing an internal combustion engine's piston, which is provided on a crown surface of the piston with a low thermal conductivity member using a porous member having a thermal conductivity lower than that of a base material of the piston. The method is characterized by comprising:

a piston forming step in which the porous member is disposed at a predetermined position of an inside of a mold, and then molten metal is injected into the mold to achieve its infiltration into each pore of the porous member, thereby fixing the low thermal conductivity member; and

a frictional pore sealing step in which, after cooling the piston, a rotatory tool is pressed against the surface of the low thermal conductivity member of the piston taken out of the mold, thereby conducting a pore sealing treatment to the pores on the surface of the porous member by frictional heat.

### Advantageous Effect of the Invention

According to the present invention, bonding strength of the low thermal conductivity member against the piston base material becomes high, and it is possible to effectively seal each pore on the porous member. As a result of this, it is possible to seek improvement of the internal combustion engine's exhaust emission performance, etc.

### BRIEF DESCRIPTION OF THE DRAWINGS

FIG. 1 is a bird's-eye view showing a partial section of a piston used in the first embodiment of the internal combustion engine's piston production method according to the present invention;

FIG. 2 is an enlarged view of Part A shown in FIG. 1;

FIG. 3A is a vertical sectional view of a porous member (low thermal conductivity member) used in the present embodiment, and FIG. 3B is an enlarged view of Part B shown in FIG. 3A.

FIG. 4A is a sectional view showing a piston production device used in the present embodiment, and FIG. 4B is a sectional view showing a part of the piston production device;

FIG. 5 is a sectional view of a piston base material taken out of the piston production device;

FIG. 6 is a schematic explanatory view of a frictional pore sealing device used in the present embodiment;

FIG. 7 are views showing details of an essential part of FIG. 6, in which FIG. 7A is a front explanatory view, and FIG. 7B is a plan explanatory view of FIG. 7A;

FIG. 8 show a frictional pore sealing step by the frictional pore sealing device of the present embodiment, in which FIG. 8A shows an explanatory view showing a condition in which a rotary tool comes down from above the low thermal conductivity member, FIG. 8B shows an explanatory view showing a condition in which an end surface of the rotary tool is in abutment with a top surface of the low thermal conductivity member, FIG. 8C shows an explanatory view showing a condition in which the pore sealing treatment has been conducted by the rotary tool on the top surface of the low thermal conductivity member;

FIG. 9 show a frictional pore sealing step by a frictional pore sealing device in the second embodiment of the present invention, in which FIG. 9A shows a condition in which an end surface of a first rotary tool is in abutment with a top surface of the low thermal conductivity member, FIG. 9B shows a condition in which a pore sealing treatment is conducted on the top surface of the low thermal conductivity member by the first rotary tool, FIG. 9C shows a condition in which the pore sealing treatment has been conducted on the low thermal conductivity member, FIG. 9D shows a condition in which an end surface of a second rotary tool is in abutment with a top surface of a central part of the low thermal conductivity member, and FIG. 9E shows a condition in which a pore sealing treatment is conducted on the central part of the low thermal conductivity member by the second rotary tool;

FIG. 10 is an explanatory view showing a condition in which a frictional pore sealing treatment condition is conducted by a frictional pore sealing device in the third embodiment of the present invention;

FIG. 11 is an explanatory view showing a movement path of a rotary tool used in the present embodiment;

FIG. 12 show a frictional pore sealing step by a frictional pore sealing device in the fourth embodiment of the present invention, in which FIG. 12A shows the first rotary tool stamping position, FIG. 12B shows a pore sealed portion and a pore non-sealed portion of the low thermal conductivity member subjected to the pore sealing treatment, FIG. 12C shows the second rotary tool stamping position, and FIG. 12D shows a stamping path on the outer circumferential side by the rotary tool; and

FIG. 13 show a frictional pore sealing step in the fifth embodiment of the present invention, in which FIG. 13A shows a condition in which a rotary tool stands by at a position above a piston base material's circular groove where a top surface of the low thermal conductivity member is exposed, FIG. 13B shows a condition in which the circular groove is filled with an aluminum alloy powder, and the rotary tool stands by at a position thereabove, and FIG. 13C shows a condition in which the frictional pore sealing is conducted by using the rotary tool against the aluminum alloy powder.

### MODE FOR IMPLEMENTING THE INVENTION

In the following, embodiments of a method for manufacturing an internal combustion engine's piston and a frictional pore sealing device of this piston according to the present invention are described in detail, based on the drawings. The piston employed in the present embodiment is applied to a so-called direct-injection gasoline engine of an in-cylinder spark-ignition type.

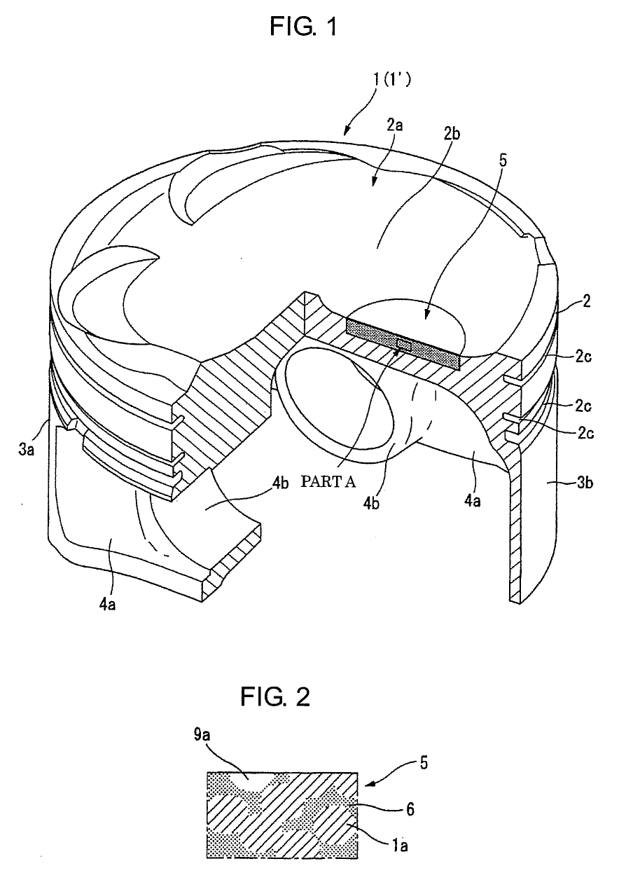

The whole of the piston 1 is integrally cast by an AC8A A1-Si based aluminum alloy as a base material. As shown in FIG. 1, the piston 1 includes: a crown part 2 formed into a substantially cylindrical shape, and defining a combustion chamber on a crown surface 2a; a thrust-side skirt part 3a and an anti-thrust-side skirt part 3b in a pair, each of which is formed integrally with an outer periphery of a lower end of the crown part 2, and has a circular arc shape; and a pair of apron parts 4a, 4b coupled to both ends of each skirt part 3a, 3b in its circumferential direction via respective connecting portions. The apron parts 4a, 4a are formed integrally with respective pin boss portions 4b, 4b for supporting both ends of a piston pin not shown.

The crown part 2 has a disc shape formed relatively thick. The crown surface 2a defining the combustion chamber is formed with a projecting outer circumferential portion and with a flat recess portion 2b having a large surface area at its center portion. A low thermal conductivity part 5 lower in thermal conductivity than the piston base material 1′s is fixed by casting in a predetermined location of a top surface of the recess portion 2b. Further, the outer periphery of the crown part 2 is formed with three piston ring grooves 2c.

The low thermal conductivity part 5 is in the location of the recess portion 2b receiving direct injection of fuel from an injector in the form of a fuel injection valve provided in a cylinder head not shown. The low thermal conductivity part 5 is fixed by casting to be integral in the recess portion 2b during production (during casting) of the piston 1 described below. As shown in FIG. 2, a part of the piston base material 1′ is infiltrated during the casting into the inside of a porous member 6 which is made of a glass material having a thermal conductivity lower than that of the piston base material 1′.

Specifically, this low thermal conductivity member 5 is composed of the porous member 6 made of a glass material, and an aluminum alloy material 1a as a part of the base material 1′, which is infiltrated into many pores 9a after dissolution of a water-soluble salt that is previously filled into the pores of the porous member 6.

[Porous Member Production Method]

As a specific method for producing the porous member 6 is described as follows, a first powder 8 that is basically a powder glass is mixed with a second powder that is a chloride compound, followed by sintering to have a shape.

Specifically, the first powder 8 is a glass powder, and is a hard and transparent substance, based on silicate, borate and phosphate, which is a non-crystalline solid exhibiting a glass transition phenomenon with rising temperature. Chemically, the first powder 8 mainly contains a silicate compound (silicate mineral) which becomes glassy state. The oxides constituting the glass are SiO₂, Al₂O₃, B₂O₃, BaO, Bi₂O₃, Li₂O, MgO, P₂O₅, PbO, SnO, TiO₂, ZnO, R₂O (R is an abbreviation of an alkali metal of Li, Na or K), or RO (R is an abbreviation of an alkaline-earth metal of Mg, Ca, Sr or Ba).

The temperature at which the first powder 8 is softened (softening point) is lower than the melting point of the second powder 9, wherein the first powder 8 has a melting point higher than or equal to 700° C.

The transition point is a temperature at which the glass structure changes, wherein the viscosity is about 1013.3 poises. The softening point is a temperature at which the glass is softened and deformed by its own weight, wherein the viscosity is about 107.6 poises.

On the other hand, the second powder 9 contains a water-soluble salt, such as sodium chloride, potassium chloride, magnesium chloride, calcium chloride, calcium carbonate, sodium carbonate, sodium sulfate, magnesium sulfate, potassium sulfate, sodium nitrate, calcium nitrate, magnesium nitrate, potassium nitrate, or sodium tetraborate. The second powder 9 may be one of them or a mixed salt of two or more of them.

It is desirable that the salt is a water-soluble salt having a melting point exceeding 700° C., such as sodium chloride, potassium chloride, magnesium chloride, calcium chloride, calcium carbonate, sodium carbonate, sodium sulfate, magnesium sulfate, potassium sulfate, or sodium tetraborate.

In this embodiment, firstly, the first powder 8 is mixed with the second powder 9, wherein the first powder 8 is borosilicate glass (glass powder ASF1898, produced by Asahi Glass Co., Ltd.), and the second powder 9 is sodium chloride.

The mixing ratio of the first powder 8 and the second powder 9 was set so that the second powder 9 was 60 to 80 volume %, and the first powder was 40 to 20 volume %. The first powder 8 and the second powder 9 were mixed to produce a mixed powder, wherein the first powder 8 and the second powder 9 were in a weight ratio of 54:46 (mixing step).

The particle size of each powder is set so that the first powder 8 has an average particle size of 4.5 μm, and the second powder 9 has an average particle size of 850 to 1300 This second power 9 is set to contain 50-80% of the particle sizes of 850 to 1300 μm.

Then, the mixed powder is set in a mold and pressure-formed, and baked by heating at a temperature of 650 to 750° C. for a period of 20 to 40 minutes. In this embodiment, the mixed powder was heated at a temperature of 700° C. for a period of 30 minutes, to obtain a sintered product (baking step).

The sintered product was immersed in a stirred hot water at 55° C. so that the inside second powder 9 (sodium chloride) was dissolved and extracted from the sintered product to obtain a porous member 6 having many pores 9a (dissolution step). In the dissolution step, the second powder 9 is subject to dissolution in hot water at 50 to 95° C. for a period of 30 minutes to 3 hours.

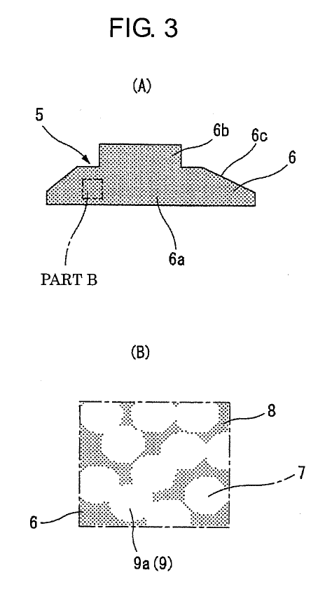

As shown in FIG. 3A, the porous member 6 includes a disk-shaped base portion 6a, and a projecting portion 6b, wherein the projecting portion 6b has a small-diameter cylindrical shape, and is formed integrally with the top surface of the base portion 6a, and wherein the periphery of the upper end of the base portion 6a is formed with a tapered surface 6c. Further, as shown in FIG. 3B, major part of the second powder 9 is dissolved and removed from the porous member 6, and the first powder 8 (glass) remains in the porous member 6, so that many pores 9a are formed around the first powder 8.

In the mixing step and the baking step described above, heating the molded body of the mixed powder of the first powder 8 (glass powder) and the second powder 9 (sodium chloride) causes the glass powder to surround and cover the particles of sodium chloride. Accordingly, the formed configuration of the porous member 6 varies depending on the mixing ratio of the first powder 8 and the second powder 9.

The inventor of the present application made an experiment in which the mixing ratio of the first powder 8 and the second powder 9 was variously changed, and got results as follows.

Specifically, for example, when the powder of sodium chloride is 80 volume % or more, and the glass powder is 20 volume % or less, the glass powder particles do not result in a melt bonding with each other by heating. Therefore, it is not possible to produce a formed body, so that the form of the body is lost when dissolved in water or hot water.

When the powder of sodium chloride is less than 50 volume %, and the glass powder is more than 50 volume %, the glass powder particles easily result in a melt bonding with each other by heating, thereby covering surroundings of the sodium chloride powder particles. Accordingly, when the powder of sodium chloride is dissolved in water or hot water thereafter, the water or hot water cannot contact the sodium chloride powder, so that the porous member 6 cannot be formed.

When the powder of sodium chloride is 50 to 80 volume %, and the glass powder is 50 to 20 volume %, open pores 9a (pores communicating from the surface to the inside) are obtained. The sodium chloride powder is not totally dissolved, but part of the sodium chloride powder is brought into a closed state by being covered with the glass powder. The quantity of sodium chloride powder in the closed state is determined by the mixing ratio of the sodium chloride powder (second powder 9) and the glass powder (first powder 8).

When the sodium chloride (second powder 9) is 80 volume %, there is no residual sodium chloride after the dissolution. As the volume percent of the second powder 9 decreases, the volume percent of the residual sodium chloride increases. Then, when the second powder 9 is 60 volume %, the residual sodium chloride powder is at 25 volume %. The residual sodium chloride powder is surrounded by the first powder 8 that is a glass powder, and functions as a thermal insulating material. On the other hand, when the porous material 6 thus obtained is impregnated with a piston cast alloy (aluminum alloy 1a) described below, and the impregnated part is finished by cutting, the residual sodium chloride appears in the cut surface.

When the appeared sodium chloride powder is dissolved and removed with water or hot water again, the cut surface becomes a composite structure of cast alloy of the piston base material 1′ and the glass that is the porous member 6. As the quantity of the sodium chloride powder increases, the dissolved quantity increases, which increases the unevenness of the surface and thereby increases the area of the surface.

The residual sodium chloride increases as the volume percentage of the sodium chloride decreases.

Then, most of the second powder 9 is removed, and the porous member 6 composed mainly of the first powder 8 (glass) is placed in a vacuum casting mold 10 for molding the piston 1, and part of the base material 1′ is infiltrated into the pores of the porous member 6 during molding of the piston 1, to embed the low thermal conductivity part 5 integrally in the crown surface 2a.

[Piston Casting Mold Device]

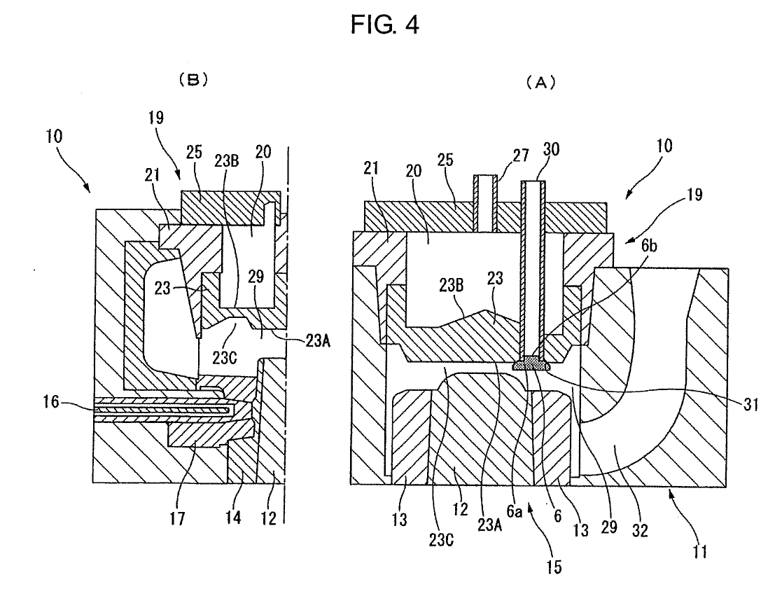

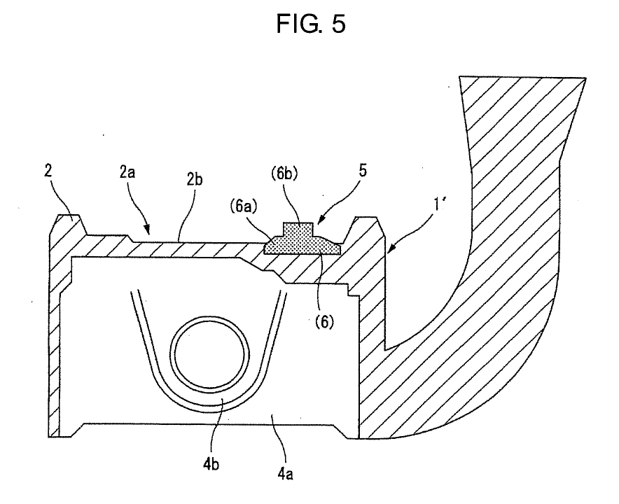

The vacuum casting mold 10 is the same as that described in the above-mentioned Japanese Patent Application Publication 2014-25418. Therefore, it is briefly explained, based on FIGS. 4A and 4B.

Specifically, the mold 10 includes a mold 11, and a core 15 in a lower part of the mold 11, wherein the core 15 is formed as a combination of a plurality of split cores, such as a center core 12, and a Philip core 13 and a side core 14 arranged around the center core 12.

The mold 10 is provided with left and right wrist pins 16 extending horizontally and facing each other for forming a cooling passage for circulating cooling water therein.

The mold 10 further includes a mold bush 17 for supporting the wrist pin 16, and a top core 19 in the upper part, which is removable from the mold 11. This top core 19 includes an outer top core 21 and an inner top core 23, wherein the outer top core 21 has a space as an example of a vacuum vent section 20, and the inner top core 23 is provided integrally with the outer top core 21.

The outer top core 21 is provided with an adapter 25 in the upper end part for sealing the vacuum vent section 20, and is provided with a first communication pipe 27 substantially in the center of the adapter 25. The first communication pipe 27 communicates with the vacuum vent section 20, and is connected to a negative pressure generator such as a vacuum pump not shown.

The inner top core 23 is arranged to face the core 15, and forms a cavity 29 between the core 15 and the mold 11. The inner top core 23 is formed as an air-permeable mold (porous mold) made of a porous material obtained by sintering an iron-based metal powder such as an SUS material.

A cavity surface 23A that faces the core 15 of the inner top core 23 is formed as a transfer surface for transferring the crown surface 2a of the piston 1 when molding the piston 1 as a product by pouring a molten aluminum alloy into the cavity 29. The cavity surface 23A is formed as a finished surface by electrical discharge machining.

Since the cavity surface 23A of the inner top core 23 is processed as a product-level finished surface by electric discharge machining without cutting and polishing, there is no possibility that the metal powder particles are crushed to block the pores between the particles, and the air permeability of the pores between the powder particles is maintained satisfactorily.

As shown in FIG. 4(A), at the position of the inner top core 23 corresponding to the portion of the crown surface 2a where the recess portion 2b is formed, there is provided a second communication pipe 30 which is a metal pipe, and extends in the vertical direction through the inner top core 23, the vacuum vent section 20, and the adapter 25. The lower end portion of the second communication pipe 30 is formed with a retaining recess 31 having a conical shape for retaining the porous member 6. Namely, the porous member 6 is retained in the predetermined location in the cavity surface 23A of the inner top core 23 in advance.

The upper end portion of the second communication pipe 30 is connected to a negative pressure generator such as a vacuum pump not shown, similar to the first communication pipe 27. Accordingly, by operation of the negative pressure generator, the inside of the porous member 6 retained in the retaining recess 31 is depressurized to a negative pressure, so that molten aluminum is infiltrated into the many pores 9a as described below.

As described above, the inner top core 23 is formed in a porous form. Accordingly, when the vacuum vent section 20 is brought into negative pressure state, gas in the cavity 29 is sucked and vented through the inner top core 23 to the vacuum vent section 20 and then to the outside. The molten aluminum alloy poured into the cavity 29 is sucked into direct contact with the cavity surface 23A (transfer surface) of the inner top core 23, so that the shape of the cavity surface 23A is transferred.

The mold 11 is formed with a runner 32 for pouring the molten material into the cavity 29, wherein the runner 32 is communicated with the lower portion of the cavity 29.

<Piston Casting Method>

Accordingly, for casting of the piston 1 with the mold 10, the molten aluminum alloy is poured into the cavity 29 through the runner 32 of the mold 11, and the vacuum vent section 20 is subject to a negative pressure. Accordingly, it is possible to effectively vent the gas from the cavity 29.

Simultaneously, the porous member 6 is depressurized to negative pressure through the second communication pipe 30 by the vacuum pump.

With this, the molten material supplied to the cavity 29 is sucked into direct and intimate contact with the cavity surface 23A (transfer surface) of the inner top core 23, because the vacuum vent section 20 is at negative pressure.

Specifically, when the molten aluminum alloy is poured into the cavity 29 through the runner 32, and the sprue is closed by the molten aluminum alloy, a motor for depressurization (not shown) is driven to vent air from the vacuum vent section 20, and thereby depressurizes the vacuum vent section 20. When this depressurization causes a differential pressure between the vacuum vent section 20 and the cavity 29, the gas in the cavity 29 is vented through the pores of the breathable mold (porous mold) 23 to the outside.

When the molten material in the cavity 29 rises gradually to be into contact with the cavity surface 23A of the inner top core 23, the molten material is sucked into intimate contact with the cavity surface 23A because the vacuum vent section 20 is depressurized. When the piston 1 is formed, the unevenness of the cavity surface 23A is transferred to the piston crown surface. The configuration that the part 23B of the recess portion 23C of the cavity surface 23A, which corresponds to the projecting part of the piston crown surface, is formed thinner than the remaining part, makes it possible to effectively perform the suction and intimate contact of the molten material at this part, and precisely form a part of the crown surface 2a even if the shape of the part of the crown surface 2a is hard to appear.

Since the inside of the porous member 6 is at negative pressure, part of the molten aluminum in the cavity 29 is sucked into the porous member 6, and is made to permeate and fill the many pores 9a from which sodium chloride has been dissolved.

As a result, as shown in FIG. 5, the low thermal conductivity part 5 impregnated with the aluminum alloy material 1a that is the piston base material 1′ is embedded integrally in and fixed to the piston base material 1′. Each pore 9a is filled with the aluminum alloy material 1a, wherein a small quantity of the second powder 9 (sodium chloride) remains.

Thereafter, the piston base material 1′, which is integrated with the low thermal conductivity part 5, is taken out from the cooled vacuum casting mold 10, and as shown in FIG. 1, a primary machining is conducted, in which a cutting process is applied to burrs formed in the outer circumferential surface of the piston base material 1′, and performed to form the piston ring grooves 2c, and applied to the upper surface of the base portion 6a and the projecting portion 6a of the low thermal conductivity part 5 (porous member 6) so that the upper surface is flush with the crown surface 2a (cutting step).

### [Pore Sealing Treatment of Low Conductivity Member's Top Surface]

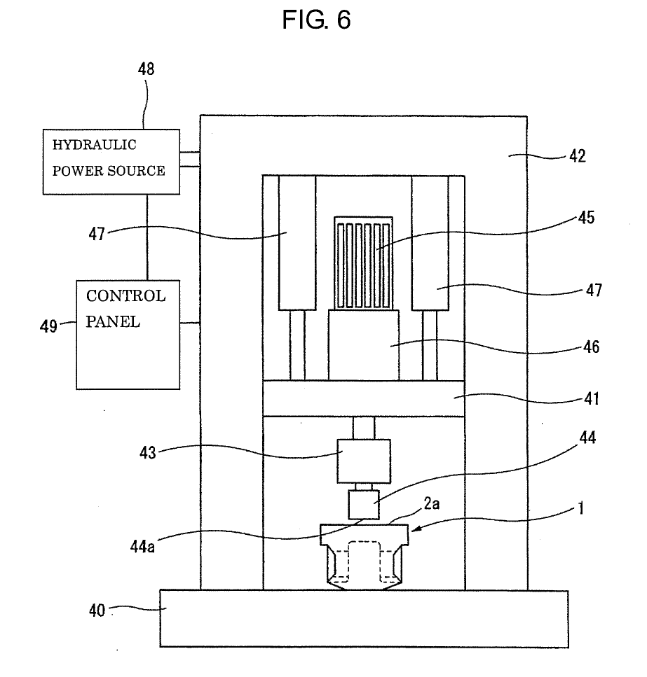

After completing the primary machining, a pore sealing treatment of pores 9a existing on the surface of the low thermal conductivity member 5 is conducted by the frictional pore sealing device shown in FIG. 6 to FIG. 8 (frictional pore sealing step).

Specifically, FIG. 6 shows a schematic structure of the frictional pore sealing device for sealing pores 9a on the surface of the low thermal conductivity member by friction. This frictional pore sealing device is one resulting from diversion of a known facility for frictional stir welding. The piston 1 as a work is to be positioned on a bed 40, and a crosshead 41 opposed to this bed 40 is elevatably supported on a gate-type frame 42. A solid cylindrical rotary tool (probe) 44 is downwardly attached to the crosshead 42 through a tool holder 43. This rotary tool 44 is driven to rotate through an electric motor 45 and a speed reduction mechanism 46 on the crosshead 42. These electric motor 45 and speed reduction mechanism 46 constitute a rotation mechanism. Simultaneously, the crosshead 42 in its entirety including the rotary tool 44 is driven to elevate by hydraulic cylinders 47 as a moving mechanism. The frictional pore sealing device is provided with a hydraulic power source 48 and a control panel 49, as is well known.

Herein, the rotary tool 44 is formed with an end surface 44 made into a circular flat surface that is one size larger than the diameter of the low thermal conductivity member 5.

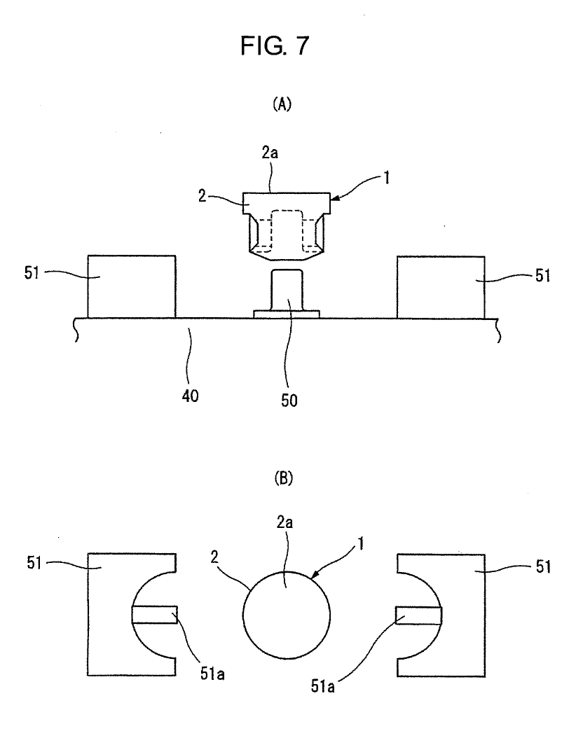

FIG. 7 shows details of a mechanism for conducting positioning of the piston 1 on the bed 40 in the frictional pore sealing device shown in FIG. 6.

FIGS. 7(A) and 7(B) are respectively a front explanatory view and a plan explanatory view of FIG. 7A. As shown in FIGS. 6(A) and 6(B), when positioning and clamping the piston 1 on the bed 40, the piston 1 is placed on a center jig 50 on the bed 40 to achieve a male-female fitting therebetween, thereby supporting the crown surface 2a from the back side, and a pair of left and right side jigs of two halves each having a projection portion 51a insertable into a pin pore on the side of the piston 1 is moved forward by a hydraulic cylinder not shown to add pressure and clamp the piston 1 from both sides by the pair of left and right side jigs 51, thereby to achieve positioning and clamping. In order to prevent deformation of the piston 1, it is desirable to support the crown surface 2a from the back side by entire surface contact. The left and right side jigs 51 and the hydraulic cylinder constitute a clamping mechanism (clamping step).

In this condition, while the rotary tool 4 is rotated, its end surface 44a is pressed against the entirety of the top surface 5a of the low thermal conductivity member 5 in a manner to cover the entirety of the top surface 5a. As mentioned above, this is the reason why the circular end surface 44a of the rotary tool 44 is formed to be one size larger than the top surface 5a of the low thermal conductivity member 5. However, unless the end surface 44a of the rotary tool 44 does not come off the top surface 5a, the rotary tool 44 may have a rotation mode in which even its axial center moves.

Furthermore, the rotating rotary tool 44 is pushed in by adding load. When reaching set load (e.g., five tons), pushed amount and frictional torque, the load is removed, the rotary tool 44 is pulled up, and its rotation is stopped.

Thus, a plastic flow layer 5b is formed on the entirety of the top surface 5a of the low thermal conductivity member 5 by a frictional heat between the end surface 44a of the rotary tool 44 and the top surface 5a of the low thermal conductivity member 5. With this, an opening portion of each pore 9a formed on the top surface 5a is sealed.

Several conditions, such as rotational speed and frictional torque of the rotary tool 44, are set to form the plastic flow layer 5b by softening a silicate compound as a glass on the top surface 5a of the low thermal conductivity member 5 (porous member 6) and an aluminum alloy member as the base material 1′ of the piston 1 by frictional heat.

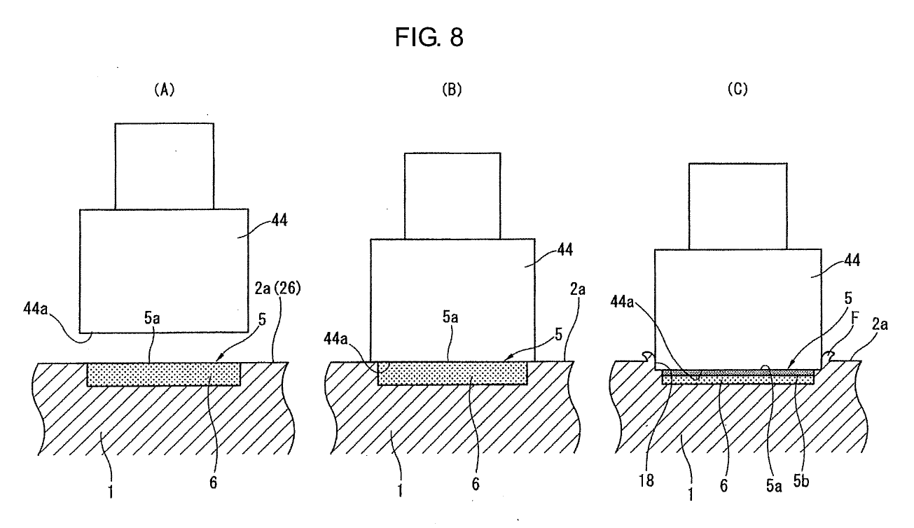

FIG. 8 are detailed views of the process of the frictional pore sealing treatment. FIG. 8(A) shows a condition in which the end surface 44a of the rotary tool 44 is not in contact with the top surface 5a of the low thermal conductivity member 5 of the piston 1 held at a predetermined position in advance. FIG. 8(B) shows a condition in which the end surface 44a of the rotary tool 44 is in contact with the entirety of the top surface 5a of the low thermal conductivity member 5 and its surrounding. Furthermore, FIG. 8(C) shows a condition in which the rotary tool 44 has been pushed against the top surface 5a of the low thermal conductivity member 5 by a set amount, thereby forming the plastic flow layer 5b on the top surface 5a of the low thermal conductivity member 5 and sealing each pore 9a.

As shown in FIG. 8(C), with the pushing rotation of the rotary tool 44, as the end shape of the rotary tool 44 is transferred, there is formed a separate recess portion 18 at a surrounding of the low thermal conductivity member 5 to be one size larger than that. Simultaneously, with the pushing of the rotary tool 44, there occurs a burr F at a surrounding of the low thermal conductivity member 5 by the base material 1′ of the piston 1 being pushed aside. This burr F is, however, cut and removed at a secondary machining.

Specifically, at the secondary machining, in order to eliminate the recess portion at the surrounding of the low thermal conductivity member 5 resulting from pushing of the rotary tool 44, cutting is conducted to make the surface of the low thermal conductivity member 5 flush with the base material 1′ of the piston 1. Therefore, at that time, even the burr F is simultaneously cut and removed.

In terms of a relationship between the diameter of the top surface 5a of the low thermal conductivity member 5 and the diameter of the end surface 44a of the rotary tool 44, it suffices that the diameter of the end surface 44a of the rotary tool 44 exceeds the diameter of the top surface 5a. Preferably, it is desirable that the diameter of the rotary tool 44 is larger than the diameter of the low thermal conductivity member 5 by about 1 mm. It is not necessary that the low thermal conductivity member 5 is necessarily circular in shape. However, in case that the rotary tool 44 is circular in shape, it is desirable that the low thermal conductivity member 5 is also circular in shape.

As mentioned above, in the present embodiment, the circular plastic flow layer 5b is formed on the top surface 5a of the low thermal conductivity member 5 by rotating the rotary tool 44 under the above-mentioned several conditions such as load, rotational torque, and rotational speed. Thus, it is possible to effectively seal openings of almost all pores 9a irrespective of the size of the opening area of each pore 9a.

With this, the injected fuel does not enter each pore 9a sealed on the side of the top surface 5a of the low thermal conductivity member 5. Therefore, it is possible to suppress lowering of internal combustion engine exhaust emission performance, etc.

### Second Embodiment

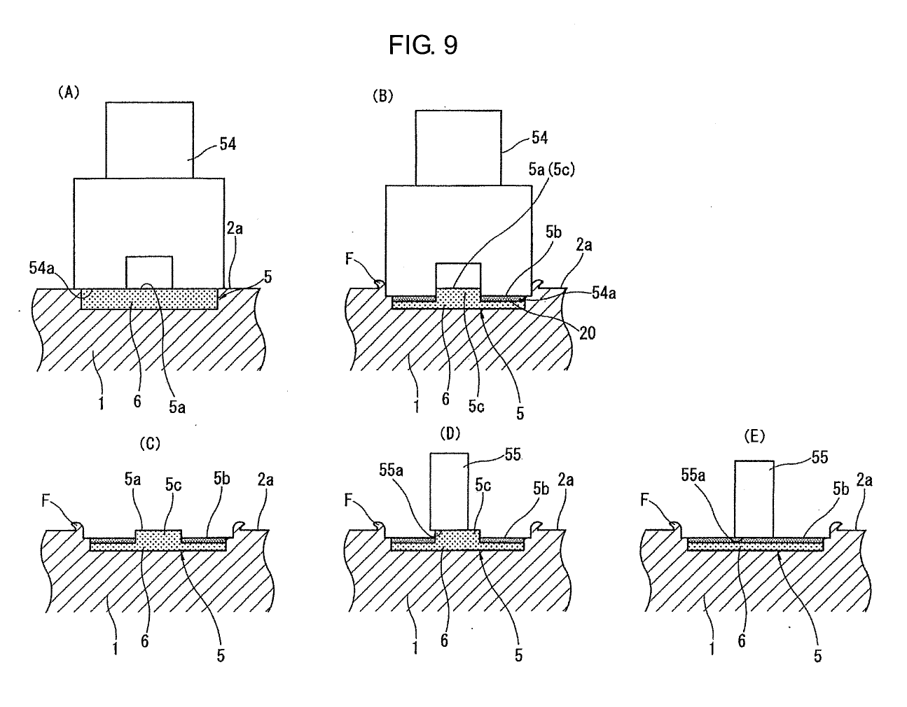

FIG. 9A to FIG. 9E show the second embodiment, in which two types of rotary tools are prepared, and a two-step pore sealing treatment is conducted on the top surface 5a of the low thermal conductivity member 5.

Specifically, at the first step, as shown in FIGS. 9A and 9B, there is used a first rotary tool 54 in which, similar to that of the first embodiment, the cross-sectional area is slightly larger than the outer diameter of the low thermal conductivity member, but its end portion is formed to have a hollow cylindrical shape; and the end surface 54a of the end portion is formed to have an annular shape.

At the second step, as shown in FIGS. 9D and 9E, a pore sealing treatment is conducted by using a second rotary tool 55 having a cylindrical shape, in which the outer diameter of an end surface 55a of an end portion is slightly smaller than the outer diameter of the end portion of the first rotary tool 54 and the outer diameter of the after-mentioned center portion 5c of the low thermal conductivity member 5.

Firstly, as shown in FIGS. 9A and 9B, using the first rotary tool 54, the annular end surface 54a is pressed against the top surface 5a of the low thermal conductivity member 5 under the above-mentioned several conditions such as predetermined load and rotational torque, thereby achieving softening by frictional heat and forming an annular plastic flow layer 5b. Therefore, as shown in FIG. 9C, there is conducted a pore sealing treatment of each pore 9a positioned in an annular region on the side of a periphery of the top surface 5a of the low thermal conductivity member 5. At this time, as shown in the drawing, the center portion 5c of the low thermal conductivity member 5 not yet subjected to the pore sealing treatment has a cylindrical projection shape.

Next, the first rotary tool 54 is replaced with the second rotary tool 55. As shown in FIGS. 9D and 9E, the end surface 55a of the second rotary tool 55 is pressed and rotated against the top surface of the projecting center portion 5c of the low thermal conductivity member 5 at a position slightly deviated from the center portion 5c in the outward radial direction. As it is, the second rotary tool 55 is moved with rotation to make a circle in a bridging condition between the center portion 5c and a portion on its outer circumferential side where the plastic flow layer 5b has already been formed. With this, the same plastic flow layer 5b as that on the outer circumferential side is formed by frictional heat on the top surface of the center portion 5c.

Thus, the reason why the two-step pore sealing treatment is conducted by replacing the first rotary tool 54 with the second rotary tool 55 is that, in the case of using the single rotary tool 44 as in the first embodiment, the pore sealing treatment proceeds by firstly forming the plastic flow layer 5b on the outer circumferential side having a larger circumferential speed of the rotary tool 44, but, in case that the rotary tool 44 is deformed depending on its load and rotational speed, there is a fear that the speed of the center portion of the low thermal conductivity member 5 becomes slower as both of the rotational speed and the load become larger by simply rotating the rotary tool 44, thereby generating a non-plastic flow layer and resulting in not obtaining a sufficient pore sealing effect.

Thus, the two-step pore sealing treatment is conducted on the inner and outer circumferential sides of the low thermal conductivity member 5 as in the present embodiment. With this, it is possible to form the plastic flow layer 5b on the entirety of the top surface 5a of the low thermal conductivity member 5 to conduct an effective pore sealing treatment.

According to the present embodiment, it is possible to make the entirety of the top surface 5a of the low thermal conductivity member flat. Therefore, a portion to be removed in the subsequent finishing becomes small, and a post-treatment becomes easy.

### Third Embodiment

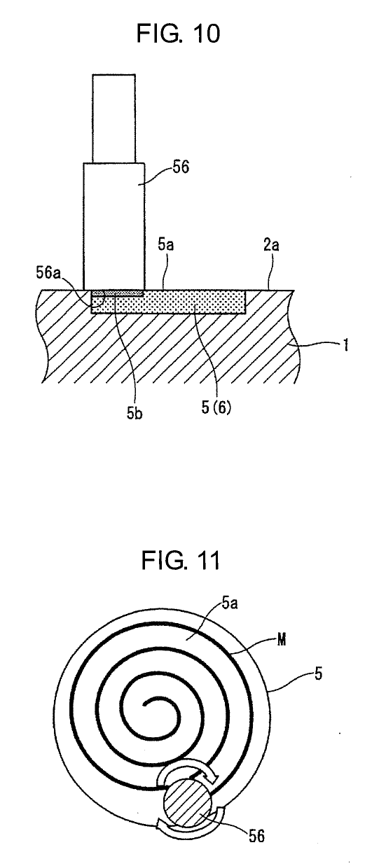

FIG. 10 and FIG. 11 show the third embodiment. In this embodiment, using a moving mechanism not shown in the drawings besides the above-mentioned rotational mechanism, a single rotary tool 56 is moved to make a spiral shape on the top surface 5a of the low thermal conductivity member 5 while it is rotated thereon.

Specifically, the rotary tool 56 is formed such that the outer diameter of an end surface 56a is sufficiently smaller than the outer diameter of the low thermal conductivity member 5. The end surface 56a is moved by the moving mechanism on the top surface 5a of the low thermal conductivity member 5 to make a spiral shape from the outer circumferential side to the center side.

As shown in FIG. 11, the spiral movement path M is designed to make a spiral shape from the outer circumferential side to the inner circumferential side (center side) to have a partial overlap of the end surface 56a of the rotary tool 56 between inner and outer paths. Furthermore, it is moved in a manner to cover the entirety of the periphery on the outer circumferential side of the top surface 5a of the low thermal conductivity member 5.

Therefore, according to this embodiment, the single rotary tool 56 is moved on the top surface 5a of the low thermal conductivity member 5 to make a spiral shape from the outer circumferential side to the center side. With this, it is possible to form a uniform plastic flow layer 5c on the entirety of the top surface 5a. That is, while conducting a plastic fluidization with the end surface 56a of the rotary tool 56 having an area smaller than that of the top surface 5a of the low thermal conductivity member 5, it is moved to expand that to the entirety. Therefore, it is possible to form a uniform plastic flow layer 5c to the entirety.

Moreover, since the pressing area of the rotary tool 56 is small, it becomes possible to conduct that with a small load. This makes it possible to make the device smaller.

Furthermore, since the spiral movement is continuously conducted by the single rotary tool 56, it is possible to improve the pore sealing treatment operation efficiency.

It is also possible to move the rotary tool 56 by the moving mechanism 56 to make a spiral shape from the center side to the outer circumferential side of the low thermal conductivity member 5.

### Fourth Embodiment

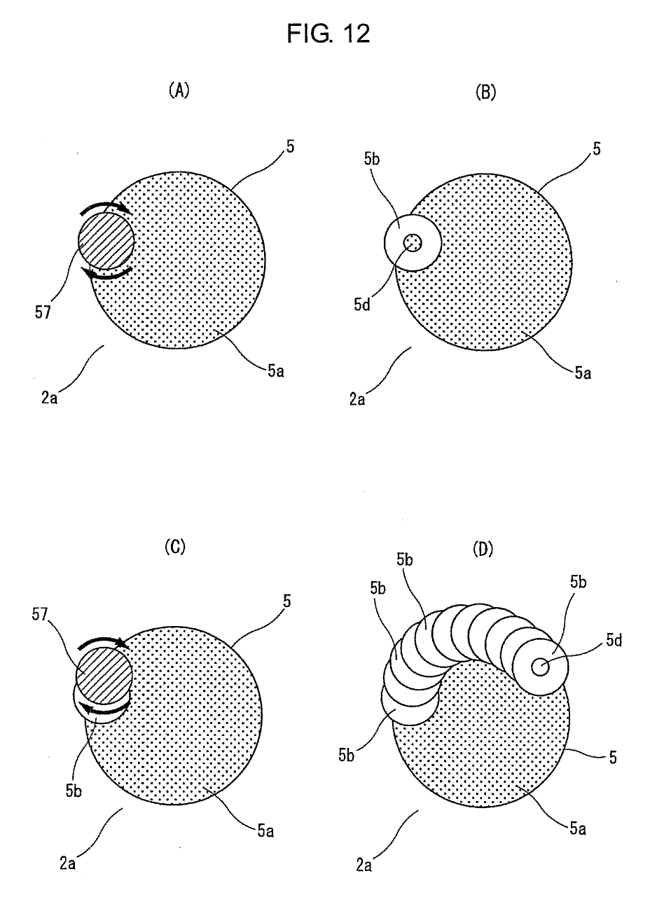

FIG. 12 shows the fourth embodiment. In this embodiment, a rotary tool 57 is subjected to a vertical movement in a stamping manner against the top surface 5a of the low thermal conductivity member 5, and it is constituted to move from the outer circumferential side to the inner circumferential side (center side) to make a circle while repeating the stamping movement.

The rotary tool 57 is formed such that its outer diameter is sufficiently smaller than the top surface 5a of the low thermal conductivity member 5, similar to that of the third embodiment. Furthermore, while the end surface 40a rotated, it is once pressed against the top surface 5a of the low thermal conductivity member 5 by a stamping mechanism as the moving mechanism not shown in the drawings. Then, it is once raised and moved in a circumferential direction to have an overlap of the center portion 5d of the pressed section. Herein, it is lowered again to conduct the pressing operation. While repeating these stamping movement in the circumferential direction and the travel in the circumferential direction, a plastic fluidization is conducted in order in the form of a small circular shape to form the plastic flow layer 5b on the entirety of the top surface 5a of the low thermal conductivity member 5.

Specifically, as shown in FIGS. 12A and 12B, firstly, while rotated, the rotary tool 57 is once pressed in a condition to extend over the crown surface 2a on the outer circumferential side of the low thermal conductivity member 5, thereby forming a circular plastic flow layer 5b on this part. Then, the rotary tool 57 is once raised and moved in a circumferential direction by a predetermined distance. As shown in FIG. 12C, it is positioned at a position to cover a center portion (outlined portion) 5d of the plastic flow layer 5b. Under this condition, it is moved down and rotated while pressed against the top surface 5a, thereby forming the next circular plastic flow layer 5b.

Then, as shown in FIG. 12D, while repeating the above-mentioned stamping movement and circumferential travel in order, circular plastic flow layers 5b are formed on the entirety of the outer circumferential portion of the low thermal conductivity member 5.

After forming the plastic flow layer 5b on the entirety of the outer circumferential portion, the rotary tool 57 is inwardly moved to a position covering a part of the circular plastic flow layer 5b of the outer circumferential portion. Here, circular plastic layers 5b are formed by repeating again the same stamping movement and circumferential travel as above. Then, these sequential stamping movement and circumferential travel are further repeated on the inner circumferential side. At the last center portion of the low thermal conductivity member 5, the treatment is conducted by the rotary tool 57 at a position covering the center portion 5d of the plastic flow layer 5b to eliminate the non-plastic flow layer.

Thus, in the present embodiment, the rotary tool 57 is not slid on the top surface 5a of the low thermal conductivity member 5, but is moved in a stamping manner. Therefore, it is possible to effectively form the plastic flow layer 5b on the entirety of the top surface 5a of the low thermal conductivity member 5.

According to the present embodiment, it is possible to make the rotary tool 57 small. It is possible to conduct that with a small load, and it is possible to make the stir condition of the frictional stir portion uniform. Furthermore, due to the stamping movement, there is no effect of burr occurring at a surrounding of a range where the rotary tool 57 has been pressed. Therefore, reliability is improved.

Since other structures are similar to those of each embodiment mentioned above, it is possible to obtain similar effects.

### Fifth Embodiment

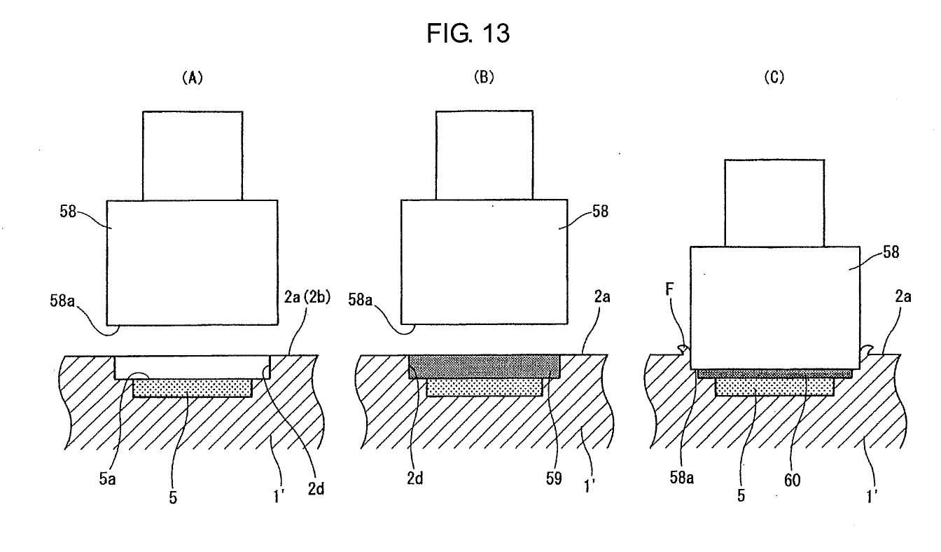

FIG. 13 show the fifth embodiment. A circular groove 2d that is a recess portion larger than the outer diameter of the low thermal conductivity member 5 is formed on the top surface side of the low thermal conductivity member 5 embedded in the interior of the crown surface 2a. The inside of the circular groove 2d is filled with, for example, an aluminum alloy powder 59 that is the same material as the piston base material 1′. Then, a rotary tool 58 is pressed and rotated at its flat circular end surface 58a against this aluminum alloy powder 59, thereby achieving a frictional bonding onto the top surface 5a of the low thermal conductivity member 5.

Specifically, firstly, when casting the piston 1, the low thermal conductivity member 5 is integrally embedded in the inside of the crown surface 2a. Then, the circular groove 2d is formed, for example, by machining on the side of the top surface 5a of this low thermal conductivity member 5. On the bottom surface side of this circular groove 2d, the entirety of the top surface 5a of the low thermal conductivity member 5 is in an exposed condition. It is also possible to form the circular groove 2d together with fixing of the low thermal conductivity member 5 (porous member 6) by using a circular core when casting the piston.

After casting the piston 1, as shown in FIG. 13B, the inside of the circular groove 2d is filled with the aluminum alloy powder 59. Then, as shown in FIG. 13C, the flat end surface 58a of the rotary tool 58 is pressed from above the aluminum alloy powder 59 and rotated. With this, the aluminum alloy powder 59 is subjected to a frictional bonding to the top surface 5a of the low thermal conductivity member 5, thereby forming a cover, aluminum alloy surface layer 60. By this surface layer, it is possible to seal respective openings of the pores 9a.

In particular, in the present embodiment, the aluminum alloy powder 59 is directly subjected to a frictional bonding to the top surface 5a of the low thermal conductivity member 5. Therefore, the aluminum alloy powder 59 infiltrates into each pore 9a. This makes it possible to more effectively seal each pore 9a.

In this embodiment, the circular groove 2d is filled with the aluminum alloy powder. Instead of this, it is also possible to accommodate and dispose an aluminum alloy member previously formed into a disk shape.

The present invention is not limited to the above-mentioned embodiment's structures. For example, it is possible to freely change components of the first powder 8 and the second powder 9, depending on material, component, etc. of the piston 1.

Furthermore, the shape of the end surfaces 44a, 54a, 55a, 56a, 57a of the rotary tools 44, 54, 55, 56, 57 is not limited to flat shape, but may be curved shape.

1.-18. (canceled)

19. A method for producing an internal combustion engine's piston provided on a crown surface of the piston with a low thermal conductivity member using a porous member having a thermal conductivity lower than that of a base material of the piston, the method for producing an internal combustion engine's piston comprising:
a step of clamping the piston in a condition in which the crown surface is provided with the low thermal conductivity member prepared by impregnating a pore of the porous member with a molten metal; and
a frictional pore sealing step of subjecting a pore on a surface of the porous member to a pore sealing treatment through frictional heat by pressing a rotary tool against a surface of the low thermal conductivity member in a condition that the piston is clamped.

20. The method for producing an internal combustion engine's piston as claimed in claim 19, wherein the pore sealing treatment is conducted in the frictional pore sealing step, while moving a position where the rotary tool is pressed against the surface of the porous member.

21. The method for producing an internal combustion engine's piston as claimed in claim 20, wherein the pore sealing treatment is conducted in the frictional pore sealing step by pressing the rotary tool against the surface of the low thermal conductivity member, while moving the rotary tool in a stamping mode.

22. The method for producing an internal combustion engine's piston as claimed in claim 21, wherein the rotary tool is moved in the stamping mode such that an outer circumferential portion of an end surface of the rotary tool covers a center portion of a region that has previously been subjected to the pore sealing treatment.

23. The method for producing an internal combustion engine's piston as claimed in claim 22, wherein an entirety of the surface of the low thermal conductivity member is subjected to the pore sealing treatment in the frictional pore sealing step.

24. The method for producing an internal combustion engine's piston as claimed in claim 23, wherein, in the frictional pore sealing step, the moving is spiral from a center to an outside on the surface of the low thermal conductivity member.

25. The method for producing an internal combustion engine's piston as claimed in claim 20, wherein, in the frictional pore sealing step, the pore sealing treatment is conducted by continuously and slidingly moving an end surface of the rotary tool on the surface of the low thermal conductivity member, while pressing the end surface of the rotary tool against the surface of the low thermal conductivity member.

26. The method for producing an internal combustion engine's piston as claimed in claim 25, wherein, in the frictional pore sealing step, the pore sealing treatment is conducted by continuously and slidingly moving the end surface of the rotary tool on an entirety of the surface of the low thermal conductivity member.

27. The method for producing an internal combustion engine's piston as claimed in claim 26, wherein, in the frictional pore sealing step, the pore sealing treatment is conducted by slidingly moving the end surface of the rotary tool in a spiral mode from a center side to an outside or from the outside to the center side of the surface of the low thermal conductivity member.

28. The method for producing an internal combustion engine's piston as claimed in claim 19, wherein, in the frictional pore sealing step, the pore sealing treatment is conducted on an outer circumferential portion of the surface of the low thermal conductivity member by an annular end surface of the rotary tool, and then the pore sealing treatment is conducted on a remaining center portion of the surface of the low thermal conductivity member by another rotary tool having a circular end surface having a diameter smaller than that of the end surface of the rotary tool.

29. The method for producing an internal combustion engine's piston as claimed in claim 19, further comprising a cutting step of cutting the surface of the low thermal conductivity member after the frictional pore sealing step.

30. The method for producing an internal combustion engine's piston as claimed in claim 19, wherein the porous member is composed of a metal shaped body comprising a combination of a metal powder material identical with the base material of the piston and a glass powder material having a thermal conductivity lower than that of the metal powder material.

31. The method for producing an internal combustion engine's piston as claimed in claim 19, wherein, in the frictional pore sealing step, the pore sealing treatment is conducted by rotating an end surface of the rotary tool in a condition that an entirety of the surface of the low thermal conductivity member is covered with the end surface of the rotary tool.

32. The method for producing an internal combustion engine's piston as claimed in claim 19, wherein an end surface of the rotary tool is flat.

33. The method for producing an internal combustion engine's piston as claimed in claim 19, wherein the low thermal conductivity member is fixed by disposing the porous member at a predetermined position of an interior of a mold and then injecting a molten metal into the mold to impregnate the pore of the porous member with the molten metal.

34. A method for producing an internal combustion engine's piston, comprising:
a piston forming step in which a low thermal conductivity member is fixed in an inside near a crown surface of the piston by impregnating a pore of a porous member having a thermal conductivity lower than that of a base material of the piston with a molten metal of the base material of the piston;
a recess portion forming step in which a recess portion is formed at a region of the crown surface of the piston where the low thermal conductivity member is positioned, such that an entirety of a top surface of the low thermal conductivity member is exposed;
a sealing material disposing step in which a sealing material that is a material substantially identical with the base material of the piston is disposed on the top surface of the low thermal conductivity member in the recess portion; and
a frictional sealing step in which a pore on a surface of the low thermal conductivity member is sealed by pressing a rotary tool against a top surface of the sealing material to soften the sealing material by frictional heat.

35. A frictional pore sealing device for an internal combustion engine's piston provided on a crown surface of the piston with a low thermal conductivity member using a porous member having a thermal conductivity lower than that of a base material of the piston, the frictional pore sealing device for the internal combustion engine's piston comprising:
a clamping mechanism for clamping the piston provided on the crown surface with the low thermal conductivity member;
a rotating mechanism for conducting a pore sealing treatment by generating frictional heat as a result of rotating an end surface of the rotating mechanism while pressing the end surface against a surface of the low thermal conductivity member; and
a moving mechanism for moving a rotary tool of the rotating mechanism or the piston itself to a predetermined position where the pore sealing treatment can be conducted.

36. The frictional pore sealing device for an internal combustion engine's piston as claimed in claim 35, wherein the moving mechanism is provided for conducting a pore sealing treatment to a pore on the surface of the low thermal conductivity member by the end surface of the rotary tool and then conducting a pore sealing treatment while moving again the rotary tool in a stamping mode to another position after moving the rotary tool away from the surface.
